(19) United States
(12) Patent Application Publication
(10) Pub. No.: US 2020/0183029 A1
(43) Pub. Date: Jun. 11, 2020

(54) A PROBE INTENDED TO BE PARTIALLY INTRODUCED INTO A GROUND FROM A FLYING VEHICLE, RELATED ASSEMBLY AND METHOD

(71) Applicant: TOTAL SA, COURBEVOIE (FR)

(72) Inventors: Francis CLEMENT, PAU (FR); Florent BERTINI, PAU (FR); Sandra BARBOUTEAU, PAU CEDEX (FR); Isabella MASONI, PAU CEDEX (FR); Olivier DE PELLEGARS, PAU (FR); Paul BARBIER, PAU (FR)

(73) Assignee: TOTAL SA, COURBEVOIE (FR)

(21) Appl. No.: 16/620,452

(22) PCT Filed: Jun. 7, 2018
(86) PCT No.: PCT/EP2018/065091

§ 371 Date: Dec. 6, 2019

(30) Foreign Application Priority Data
Jun. 8, 2017 (EP) 17305689.6

(51) Int. Cl. G01V 1/18; G01V 1/00; G01V 1/22; G01V 1/16; A01C 14/00; B64C 39/02; B64D 1/02

(52) U.S. Cl. CPC G01V 1/181; G01V 1/003; G01V 1/22; G01V 1/162; B64C 2201/12; B64C 39/024; B64D 1/02; G01V 2210/1295; B64C 2201/027; A01C 14/00

(57) ABSTRACT

The probe includes a hollow casing defining a closed inner compartment, the hollow casing having at least an end to be placed in contact with the ground; at least a sensor received in the closed inner compartment, the sensor being able to sense a physical quantity related to the ground; and at least an emitter received in the closed inner compartment, the emitter being able to send data representative of the physical quantity sensed by the sensor. Also, at least a power source received in the closed inner compartment, the power source being able to power the sensor and/or the emitter. At least part of the sensor and/or at least part of the emitter is biodegradable.

### CROSS REFERENCE TO RELATED APPLICATIONS

This is a U.S. National Phase Application under 35 under § 371 of International Patent Application No. PCT/EP2018/065091, filed Jun. 7, 2018, which claims priority of European Patent Application No. 17305689.6, filed Jun. 8, 2017. The entire contents of which are hereby incorporated by reference.

### FIELD OF THE INVENTION

The present invention concerns a probe intended to be partially introduced into a ground from a flying vehicle, to carry out measurements in the ground, the probe comprising:

a hollow casing defining a closed inner compartment, the hollow casing having at least an end to be placed in contact with the ground;

at least a sensor received in the closed inner compartment, the sensor being able to sense a physical quantity related to the ground;

at least an emitter received in the closed inner compartment, the emitter being able to send data representative of the physical quantity sensed by the sensor;

at least a power source received in the closed inner compartment, the power source being able to power the sensor and/or the emitter.

### BACKGROUND

The probe is intended to be partially introduced into a ground through its own velocity, mass and deceleration thereupon its impact with said ground from the flying vehicle.

Each probe is in particular intended to form a receiver including at least a seismic sensor to conduct a geophysical survey in a region of interest.

### SUMMARY

The region of interest is notably a region with a difficult access. The region in particular comprises a high density of vegetation, such as a forest, such as a tropical forest. Also, the region may comprise rugged terrain such as hills (for example foothills), cliffs and/or mountains. Also, the region may comprise dangerous to access areas, such as areas with unexploded ordinances (UXO's).

The method can also be applied to any region of interest.

Geophysical measurements obtained during such a survey are critical in building a sub-surface earth image representative of the particular geology in the region of interest, in particular to determine the location of potential reservoirs of oil and gas.

Such a geophysical survey is for example conducted by placing an array of seismic sources into the ground in the region of interest and by deploying seismic sensors able to record reflections of seismic signals produced by the successive sources on the different layers of the earth.

The survey generally requires implanting the sources at various locations, and partially introducing receivers in the ground along several lines to create a dense array of receivers.

The quality of the image obtained after the survey is generally a function of the surface density of sources and/or of receivers. In particular, a significant number of receivers have to be put in place in the ground to obtain an image of good quality. This is in particular the case when a three-dimensional image is required.

Placing sources and sensors in a remote region of interest may be a tedious, dangerous and expensive process. In particular, when the region is barely accessible, such as in a tropical forest and/or in a region with uneven terrain, and/or in a region with UXOs, the sources and the sensors must be carried at least partially by foot by teams of operators. In many cases, clearings must be opened in the forest to place on the ground the relevant equipment and operators. Trails must then be cleared in the forest to put in place the receivers.

These tasks create a strong environmental impact in the region of interest and may induce significant health and safety risks for the operators.

The set-up of the receivers and/or the sources in the ground is a long process which often requires drilling the ground, and in the case of the receivers, ensuring that the coupling between the receiver and the ground is adequate.

Moreover, in order to limit environmental impact, the receivers must be removed after collecting the relevant data. This requires another long and costly operation to reach the receivers, and remove them from the ground. Such an operation has also an impact on the environment and creates additional risks for the operators.

In order to partially overcome this problem, WO 2016/054133 discloses biodegradable sleeves for providing coupling between the receiver and the ground. The sleeves are inserted in a hole drilled in the ground. A receiver is then introduced in a central cavity of the sleeve for carrying out the measurements. The receivers are then removed after the measurement. The biodegradable sleeve stays in place, which limits the environmental impact.

Nevertheless, such a solution is not entirely satisfactory. Indeed, it still requires at least an operation for installing the receivers and another operation for removing each receiver. This process is time and fuel consuming, involves health and safety risks for the operators and generates a strong environmental impact, for example due to logging of large areas of forest.

One aim of the invention is to obtain a sensor for conducting a seismic survey which is safe and cost-effective to install, while minimizing the impact in the region of interest and limiting risks for the operators.

To this aim, the subject-matter of the invention is a probe of the above-mentioned type, characterized in that at least part of the sensor and/or at least part of the emitter is biodegradable.

The probe according to the invention may comprise one or more of the following features, taken solely or according to any potential technical combination:

at least part of the sensor and/or at least part of the emitter is biodegradable in less than 24 months, preferably in less than 12 months, more preferably in less than 6 months after contact of the probe with the ground;

at least part of the hollow casing defining the closed inner compartment is biodegradable in less than 24 months, preferably in less than 12 months, more preferably in less than 6 months after contact of the probe with the ground.

at least part of the hollow casing defining the closed inner compartment is biodegradable;

the hollow casing is fully biodegradable;

the sensor and/or the emitter comprise a support and electronic circuits carried on the support, at least part of the support being biodegradable;

the power source is at least partially biodegradable;

the hollow casing comprises at least a partition defining an outer surface of the probe and an inner surface delimiting the closed inner compartment, the partition being at least partly biodegradable;

the probe has a mass of less than 1 kg;

more than 90% in mass of the probe is biodegradable;

at least part of the sensor and/or at least part of the emitter and/or at least part of the hollow casing is chemically degradable;

the hollow casing comprises a tubular partition defining a rear opening opposite the end and a rear closing part having at least a protruding fly control member;

the sensor is a geophysical sensor, in particular a geophone or a MEMS.

The invention further concerns a ground survey assembly comprising:

a flying vehicle able to fly over the ground;

at least a probe as defined above, carried by the flying vehicle;

a launching unit, able to separate the probe from the flying vehicle above the ground.

The assembly according to the invention may comprise one or more of the following features, taken solely or according to any technical feasible combination:

the flying vehicle is an unmanned aerial vehicle.

The invention further concerns a method for surveying a ground, comprising the following steps:

flying a flying vehicle of a ground survey assembly as defined above above a ground;

activating the launching unit to separate at least a probe from the flying vehicle;

falling of the probe from the flying vehicle to the ground;

contact of the probe with the ground;

measurement of at least a physical quantity using the probe;

transmitting data representative of the physical quantity using the emitter

at least partial biodegradation of the sensor and/or of the emitter.

The method according to the invention may comprise one or more of the following features, taken solely or according to any technical feasible combination:

the method comprises a further step of analyzing the data transmitted by the emitter to determine at least a physical property and/or an image of the ground around the probe;

the method comprises generating a seismic stimulus in the ground, the measurement step comprising collecting a seismic signal resulting from the seismic stimulus with the sensor.

### BRIEF DESCRIPTION OF THE DRAWINGS

The invention will be better understood, based on the following description, given solely as an example, and made in reference to the following drawings, in which:

FIG. 1 is a schematic view of a region of interest comprising a ground survey assembly according to the invention;

FIG. 2 is an external partial perspective view of a probe according to the invention;

FIG. 3 is a sectional view, taken in section along an axial median plane of the probe of FIG. 2;

FIG. 4 is a detail of a functional module contained in the probe of FIG. 2;

FIG. 5 is a schematic view of a method for installing the probes according to the invention.

### DETAILED DESCRIPTION

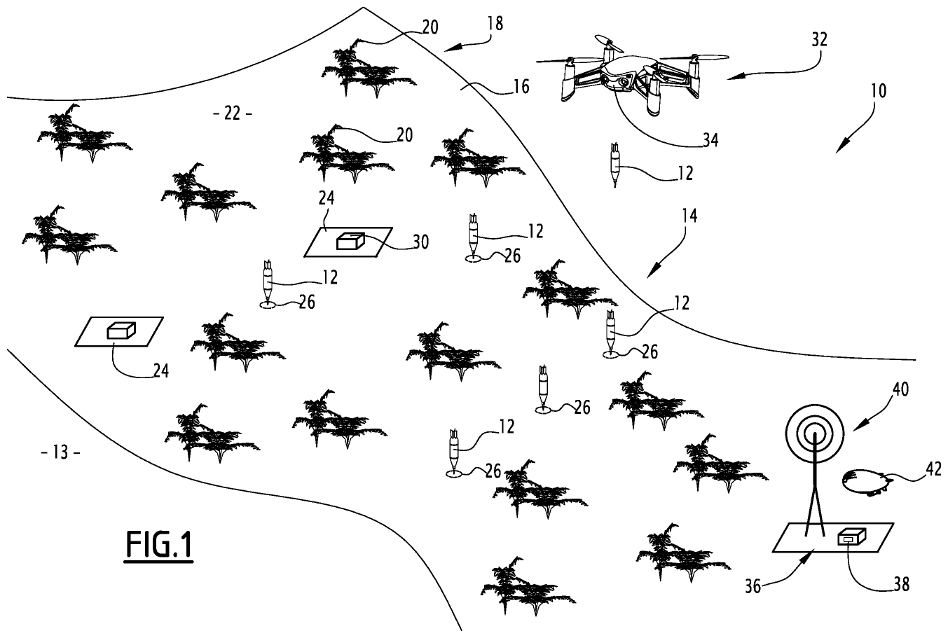

A first ground survey assembly 10 comprising at least a probe 12 according to the invention is disclosed schematically in FIG. 1.

The ground survey assembly 10 is for carrying out a geophysical survey of an onshore region of interest 14, schematically shown in FIG. 1.

The assembly 10 is used in particular to collect geophysical data and measurements for determining the physical properties of the subsurface 13 located in the region of interest and/or for building an image of the geology of the subsurface 13, preferably a tridimensional image of the subsurface 13.

The region of interest 14 is for example a region having an uneven terrain 16. The uneven terrain 16 in particular comprises hills, mountains, cliffs or any type of rugged terrain. The region of interest 14 is for example located on foothills which are difficult to access.

The region of interest 14 further comprises vegetation 18. The vegetation 18 is for example a forest, in particular a tropical forest. It comprises a high density of vegetation, for example trees 20 forming a canopy 22 which covers a majority of the surface of the ground in the region of interest 14.

The subsurface 13 located below the ground comprises layers of geological formation and potentially oil and gas reservoirs.

In the region of interest 14, the vegetation 18 defines a plurality of natural and/or artificial clearings 24 offering an access to the ground through openings in the canopy 22. The vegetation 18 in the region of interest 14 also defines sky holes 26 in the canopy 22.

The clearings 24 are spread in the region of interest 14, at a distance generally comprised between 100 m and 500 m, preferentially around 300 m, taken along the line of sight between two adjacent clearings 24.

The clearings 24 generally have a surface area greater than 25 m², at the ground level and generally greater than 900 m² at the top of the canopy 22. The seismic sources 30 can be put in place in the clearings 24.

A clearing 24 is for example defined in a OGP Standard “OGP-Helicopter Guideline for Land Seismic and Helirig operations—Report 420 version 1.1 June 2013

Sky holes 26 are generally natural. They advantageously form a vertical “light tube” between the canopy 22 and the ground.

For example, the sky holes 26 have a minimal surface area greater than 1 m², preferentially greater than 3 m2, and comprised for example between 3 m² and 20 m².

The probes 12 are able to be dropped in each sky hole 26, as will be described later.

At least a sky hole 26 has a surface area which is smaller than the surface area of the clearings 24.

The ground survey assembly 10 comprises a plurality of sources 30, able to generate a geophysical stimulus in the ground, in particular a seismic signal. The ground survey assembly 10 further comprises a plurality of at least partially biodegradable probes 12 spread in the region of interest 14 to collect geophysical data arising from the seismic signal generated by the sources 30.

In the example of FIG. 1, the ground survey assembly 10 further comprises a fleet of flying vehicles 32, able to fly above the vegetation 18 to carry each probe 12 above its point of installation, and, for each flying vehicle 32, a launching unit 34 able to separate each probe 12 carried by the flying vehicle 32 to let the probe 12 free fall to its installation point in the ground.

In a variant, the probe 12 can be launched toward the ground. The launching impulse can be obtained by the integration of a thruster (ex: pyrotechnic, turbine, propeller . . . ) in the probe 12, or by the use of a propulsion mechanism onboard the probe carrier flying vehicle 32 (e.g. launching actuator or the decompression of a spring). The impulse accelerates the fall of the probe 12 to help it penetrate further into the canopy 22 and/or the ground.

In yet another variant, the fall of the probe 12 can be slowed down by a braking mechanism (e.g. a parachute attached to the rear closing part 64). Slowing down the fall of the probe 12 can for instance avoid damages to the probe.

The ground survey assembly 10 further comprises at least a base 36 (or secondary camp), comprising at least a collection and/or analysis unit 38 and a telecommunication system 40 able to transfer data measured by the probes 12 to the collection and/or analysis unit 38, and from the collection and/or analysis unit 38 to an external station (not shown).

The base 36 advantageously comprises a helipad, night facilities for crews, and/or antenna which collect data from small antenna located in the vicinity. It is used for management of the take-off and landing. It may be used for first aid (e.g. medevac).

The external station may be located at a main camp (not shown). The main camp advantageously comprises facilities for collecting data, as well as a main computing unit, and/or a control center.

Advantageously, the ground survey assembly 10 comprises at least an additional flying vehicle 42 such as an helicopter, an airship, able to fly over the vegetation to carry the sources 30 in the clearings 24.

Each seismic source 30 is able to generate a controlled seismic energy generating a geophysical stimulus, in particular a seismic signal in the ground.

The source 30 for example may comprise an explosive, in particular dynamite, able to generate the geophysical stimulus.

The source 30 is inserted in a hole drilled into the ground, for example at a depth comprised between 0 meter and 100 meters, preferably between 5 meters and 80 meters.

In a variant, the source 30 comprises a mechanical device such as a hammer, a vibrator.

The density of sources 30 locations laid in the region of interest 14 is generally comprised between 10 source locations per km² and 100 source locations per km². Each source location can comprise one or more source 30.

Each source 30 is preferably arranged in a clearing 24. The source 30 is generally brought to the clearing 24 by the additional flying vehicle 42. It can be put in place by an unmanned ground vehicle, such as a semi automatic drilling platform.

Each probe 12 is partially introduced in the ground to sense in particular the seismic signals resulting from interactions of the seismic stimulus generated by a source 30 with the geology of the subsurface 13.

The density of probes 12 is comprised for example between 10 probes per km² and 1000 probes per km², in particular between 300 probes per km² and 500 probes per km², notably 400 probes per km².

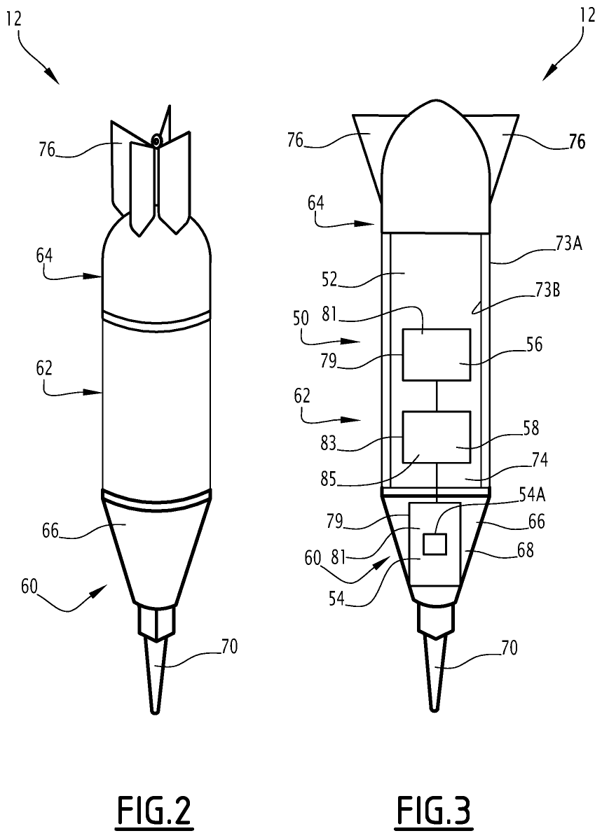

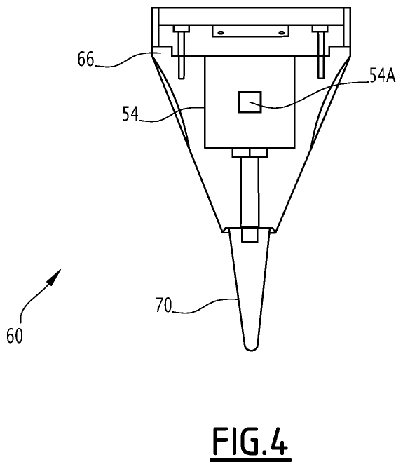

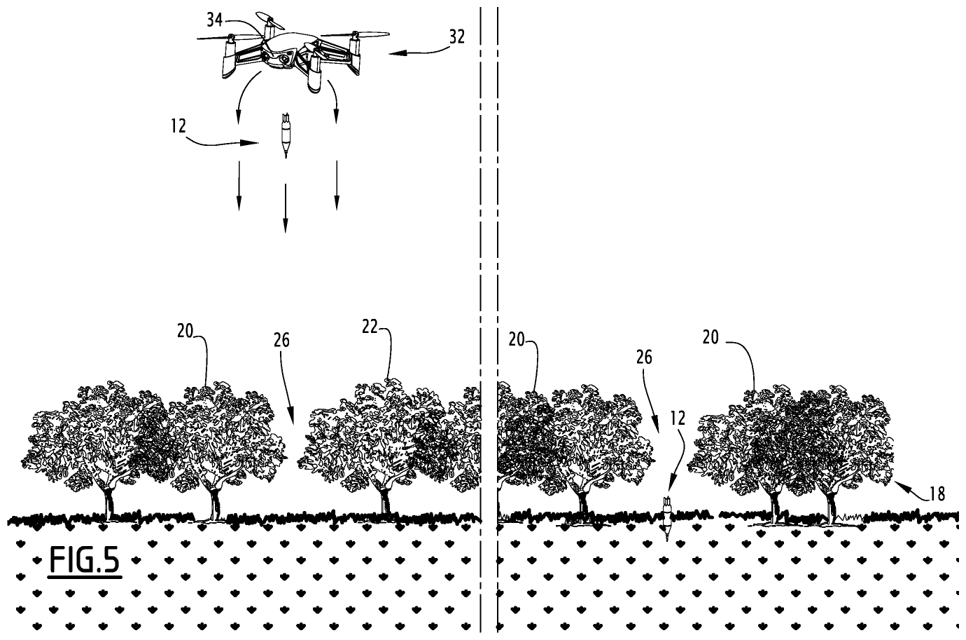

In the example shown in FIG. 2, each probe 12 has the shape of a dart. In a variant, the probe 12 has the shape of a ball or of a parallel pipe.

The probe 12 comprises a hollow casing 50 defining a closed inner compartment 52, a sensor unit 54 comprising at least a sensor 54A received in the closed inner compartment 52 to sense at least a physical quantity, in particular a seismic signal.

The probe 12 further comprises an emitter 56 able to collect and send data representative of the physical quantity sensed by the sensor unit 54, and at least a power source 58 able to power the sensor unit 54 and/or the emitter 56. The emitter 56 and the power unit 58 are also received in the closed inner compartment 52 of the hollow casing 50.

In this example, the hollow casing 50 advantageously comprises a tapered lower end 60 to penetrate the ground, a central tubular partition 62, and a rear closing part 64 mounted at the rear of the central partition 62 opposite from the tapered lower end 60.

The tapered lower end 60 comprises a profiled wall 66 defining an inner cavity 68, and advantageously, a needle-shaped solid end part 70 protruding from the profiled wall 66.

The inner cavity 68 contains the sensor unit 54 including the or each sensor 54A.

The tubular central partition 62 is here cylindrical. It delimits an inner volume 74 receiving the emitter 56 and the power unit 58.

The central partition 62 defines an outer surface 73A defining an outer surface of the probe 12 intended to be in contact with a mass of air in which the probe 12 falls from the flying vehicle 32. It also defines an inner surface 73B externally delimiting the closed inner compartment 52.

The rear closing part 64 closes the inner volume 74. It comprises a least a radially protruding fly control member 76, which provide guidance to the probe 12 when it free falls from the flying vehicle 32.

The inner volume 74 and the inner cavity 68 are preferably sealed. They together form the closed inner compartment 52 containing the sensor unit 54 including the sensors 54A, the emitter 56, and the power source 58.

At least part, and more preferably all, of the hollow casing 50 defining the closed inner compartment 52 is biodegradable.

In particular, at least part of the profiled wall 66, the central partition 62, and the rear closing part 64 and/or the tapered end 60 are made of a biodegradable material.

Moreover, at least part of the profiled wall 66, the central partition 62, and the rear closing part 64 and/or the tapered end 60 can be made of a chemically degradable material.

By “biodegradable”, it is meant a material which is able to be mineralized by soil microorganisms and or by air microorganisms. For example, a biodegradable material is a material in which more than 90% of the material is converted into carbon dioxide and water by the actions of microorganisms within two years, preferably within one year, more preferably within six months.

Biodegradability can be measured for example according to standard ASTM D5988-12 whose title is “Standard test methods for determining aerobic biodegradation of plastic materials in soil”.

By “chemically degradable”, it is meant a material which is able to be mineralized by chemical reactions with components of the soil and/or with light, in particular with UV light. For example, a chemically degradable material is a material in which more than 90% of the material loses its structure within two years, preferably within one year, more preferably within six months.

Advantageously, the biodegradable material and/or chemically degradable material is degraded in less than within 2 years, preferably within one year, more preferably within 6 months after the contact of the probe 12 with the ground.

Preferably, the hollow casing 50 is at least partly made of biodegradable plastic. Biodegradable plastics are for example components which are derived from renewable raw materials.

In a variant or in complement, the hollow casing is at least partly made of natural material such as wood and/or materials comprising vegetal fibers (for example bamboo fibers) such as biodegradable plastics containing vegetal fibers.

Examples of biodegradable plastics are aliphatic polyesters, such as polyhydroxyalkanoates (PHA), like poly-3-hydroxybutyrate (PHB), polyhydroxyvalerate (PHV), and polyhydroxyhexanoate (PHH). Other examples are polylactic acid (PLA), polybutenesuccinate (PBS), or polycaprolactone (PCL).

Preferably, the hollow casing 50 is totally made of biodegradable material, in particular biodegradable plastics.

The sensor unit 54 comprises at least a geophysical sensor 54A such as a geophone or a microelectromechanical system (MEMS) sensor.

In a variant, the sensor unit 54 comprises at least an accelerometer, and/or a thermometer.

The sensor unit 54 advantageously comprises at least one geophone, in particular three geophones and/or an accelerometer.

Each sensor 54A of the sensor unit 54 is able to sense a physical quantity, in particular a ground movement and to convert it into a signal which may be recorded.

The emitter 56 comprises a data recovery unit able to digitalize, process and store the data measured by each sensor 54A. The emitter 56 for example comprises a processor and a memory.

The emitter 56 is able to communicate with another emitter 56 of another probe 12 located in the vicinity of the probe 12 and/or with an antenna of the telecommunication system 40. It is able to transfer data representative of the physical quantity measured by each sensor 54A along time to another probe 12 and/or to an antenna of the telecommunication system 40.

According to the invention, the sensor unit 54 and/or the emitter 56 are at least partially biodegradable as defined above. Moreover, the sensor unit 54 and/or the emitter 56 can also be at least partially chemically degradable.

They comprise for example a support 79 and electronic circuit 81 carried on the support 79, at least the support 79 being at least partly biodegradable. At least the support 79 may be also at least partially chemically degradable.

The power unit 58 comprises a battery. The battery is able to power the emitter 56 and/or each sensor 56A of the sensor unit 54. The battery for example comprises a casing 83 and electrochemical material 85.

The casing 83 is at least partially biodegradable. It may also be at least partially chemically degradable.

Overall, the mass content of biodegradable material in the probe 12 is advantageously greater than 90% in mass, in particular greater than 95% in mass, preferably greater than 99% in mass, for example greater than 99.8% in mass.

The content of material which is not biodegradable and/or not chemically degradable in the probe 12 is less than 10% in mass, in particular less than 5% in mass, preferably less than 1% in mass, more preferably less than 0.2% in mass of the total mass of the probe 12.

The latter material is referred to as non-degradable, i.e. it remains structured for at least six months, in particular for at least one year, in particular for at least two years after the probe 12 has been put in contact with the ground.

The hollow casing 50, the sensor unit 54, the emitter 56 and the power unit 58 being at least partially biodegradable and/or at least partially chemically degradable, the probes 12 have a reduced environmental impact in the ground.

The low non-degradable content of the probes 12 diminishes the environmental impact when the probe 12 biodegrades or chemically degrades.

The flying vehicle 32 is for example an unmanned aerial vehicle (UAV) piloted from the base 36 to reach a launching point above a skyhole 26.

The launching unit 34 comprises a mechanical retainer able to be operated from a probe retaining configuration in which the retainer holds the probe 12 and a dropping configuration, in which the retainer frees the probe 12 to let it fall down from the flying vehicle 32.

The telecommunication system 40 comprises antennas located in at least part of the clearings 24, and/or flying antennas. It is able to collect data received from the emitter 56 of each probe 12 and to convey it to the collection and analysis unit 38 at the base 34.

The additional flying vehicle 42 is for example a helicopter, an airship or a balloon which is able to carry the sources 30 towards each clearing 24.

The installation and operation of the ground survey assembly 10 according to the invention will be now described.

Initially, a location of a plurality of sources 30 and the location of a plurality of probes 12 in the region of interest 14 are defined respectively into artificial or natural clearings 24 of the region of interest 14 and into sky holes 26 of the region of interest 14.

The sources 30 and the probes 12 are carried to the base 36. The sources 30 are then put in place in the clearings 24, advantageously by flying the additional flying vehicle 42 to each clearing 24 and by unloading each source 30 in a clearing 24.

Each source 30 is then installed in a hole drilled in the ground.

Then, each flying vehicle 32 is loaded with at least one probe 12 in the launching unit 34, preferably with several probes 12. Then, the flying vehicle 32 is flown over successive sky holes 26 and the launching unit 34 is triggered to let each probe 12 fall down, as shown in FIG. 5. The probe 12, in particular its tapered end 60 when available, penetrates the ground to couple the probe 12 with the ground.

The insertion of the probes 12 in the ground is made without the need of a man intervention on the ground. It is extremely simple and accurate, and it allows dropping a large number of probes 12, for example more than 1,000 probes, in particular more than 10,000 probes.

In operation, at least one source 30 is triggered to generate a seismic stimulus. The seismic stimulus propagates in the ground and reflects against the different layers in the subsurface 13.

A seismic signal is captured by the sensors 54A of the sensor unit 54. The signal is digitalized, conditioned and/or processed by the data recovery unit, and is stored. The collected data is then transmitted to the base 36 through the emitter 56 and the telecommunication system 40.

The data is then transmitted to the collection and analysis unit 38 by the antennas of the telecommunication system 40.

Based on the data collected by each sensor 54A of each probe 12, an image of the subsurface 13 in the region of interest 14, in particular a tridimensional image can be built with great accuracy.

Once the survey has been completed, the sources 30 are recovered. Nevertheless, the probes 12 remain in place and at least partially degrade, directly in the soil, by biodegradation and/or chemical degradation. The degradation process advantageously occurs in less than two years, in particular in less one year, preferably in six months, with more of 90% in mass of the total mass of the probe 12 being transformed.

The method for surveying the ground with the assembly 10 is therefore extremely simple to operate and has a minimal impact on the environment.

In particular, the method does not require opening large areas of vegetation 18 to put in place the sources 30 and the probes 12. It greatly reduces human intervention and limits the risks for human safety and environment.

Moreover, the hollow casing 50 of each probe and/or the components contained in the hollow casing 50 being degradable, the probes 12 are able to remain in place in the ground, without the need of a further human intervention to recover the probes 12.

The degradation of the probes 12 reduces the impact on the environment.

A large number of probes 12 can therefore be used, which enhances the image quality.

In a variant, a package of biological entities such as enzymes, nutriments favoring the development of microorganisms or chemicals (for instance oxydants or acids) able to increase the speed of biodegradation and/or chemical degradation of the hollow casing 50 and/or of the sensor unit 54 and/or of the emitter 56 and/or of the power unit 58, is included in the hollow casing 50 to enhance biodegradability and/or chemical degradability after impact with the ground. In particular, enzymes such as lipase, esterase, and alcalase, or more generally enzymes which are known to hydrolyze polylacticacid effectively, can be included in the hollow casing 50.

In a variant, seeds of vegetation are included in the hollow casing to favor reforestation of the region of interest.

In another embodiment, the rear closing part 64 of the probe 12 degrades first to generate a top opening enabling rainwater to penetrate quickly the hollow casing and ease degradation of the rest of the probe.

Advantageously, the mechanical strength of the biodegradable material in the lower part of the probe 12 is greater than the mechanical strength of the biodegradable material in the upper part of the probe 12. The biodegradable material in the upper part of the probe advantageously has a rate of degradation greater than the rate of degradation of the biodegradable material in the lower part of the probe 12.

In yet another variant, the hollow casing 50 defines openings. Tabs of a first material are inserted into the hollow casing 50 made of a second material, in order to close openings. The rate of degradation of the first material is greater than the rate of degradation of the second material.

The rate of degradation is defined by the relative amount of material, able to degrade in a unit of time. The relative amount of material is taken as the ratio of the mass of material which has been degraded to the initial mass of material.

In use, the openings are quickly opened to enable rainwater to penetrate the hollow casing and ease degradation of the rest of the probe 12.

In a variant, the probe 12 does not have a dart shape. It has for example the shape of a parallel pipe or of a ball.

1. A probe intended to be partially introduced into a ground from a flying vehicle, to carry out measurements in the ground, the probe comprising:
a hollow casing defining a closed inner compartment, the hollow casing having at least an end to be placed in contact with the ground;
at least a sensor received in the closed inner compartment, the at least one sensor being configured to sense a physical quantity related to the ground;
at least an emitter received in the closed inner compartment, the at least one emitter being configured to send data representative of the physical quantity sensed by the at least one sensor; and
at least a power source received in the closed inner compartment, the at least one power source being configured to power the at least one sensor and/or the at least one emitter;
at least part of the at least one sensor and/or at least part of the at least one emitter being biodegradable.

2. The probe according to claim 1, wherein at least part of the hollow casing defining the closed inner compartment is biodegradable.

3. The probe according to claim 1, wherein the hollow casing is fully biodegradable.

4. The probe according to claim 1, wherein the at least one sensor and/or the at least one emitter comprise a support and electronic circuits carried on the support, at least part of the support being biodegradable.

5. The probe according to claim 1, wherein the at least one power source is at least partially biodegradable.

6. The probe according to claim 1, wherein the hollow casing comprises at least a partition defining an outer surface of the probe and an inner surface delimiting the closed inner compartment, the at least one partition being at least partly biodegradable.

7. The probe according to claim 1, having a mass of less than 1 kg.

8. The probe according to claim 1, wherein more than 90% in mass of the probe is biodegradable.

9. The probe according to claim 1, wherein at least part of the at least one sensor and/or at least part of the at least one emitter and/or at least part of the hollow casing is chemically degradable.

10. The probe according to claim 1, wherein the hollow casing comprises a tubular partition defining a rear opening opposite the end and a rear closing part having at least a protruding fly control member.

11. The ground probe according to claim 1, wherein the sensor is a geophysical sensor.

12. The ground probe according to claim 1, wherein the hollow casing contains a package of biological entities able configured to increase the speed of biodegradation and/or chemical degradation of the at least one sensor and/or of the at least one emitter or wherein the hollow casing contains seeds of vegetation.

13. The ground probe according to claim 1, wherein an upper part of the probe comprises a first biodegradable material, a lower part of the probe comprising a second biodegradable material, a mechanical strength of the first biodegradable material in the lower part of the probe is greater than a mechanical strength of the second biodegradable material in the upper part of the probe.

14. The ground probe according to claim 1, wherein the hollow casing defines openings, the probe comprising tabs of a first material inserted into the hollow casing in order to close the openings, the hollow casing being made of a second material, a rate of degradation of the first material being greater than a rate of degradation of the second material.

15. A ground survey assembly comprising:
a flying vehicle configured to fly over the ground;
at least a probe according to claim 1, carried by the flying vehicle;
a launcher configured to separate the at least one probe from the flying vehicle above the ground.

16. The assembly according to claim 15, wherein the flying vehicle is an unmanned aerial vehicle.

17. A method for surveying a ground, comprising:
flying a flying vehicle of a ground survey assembly according to claim 15 above a ground;
activating the launcher to separate at least a probe from the flying vehicle;
falling of the at least one probe from the flying vehicle to the ground;
contact of the at least one probe with the ground;
measurement of at least a physical quantity using the at least one probe;
transmitting data representative of the at least one physical quantity using the at least one emitter; and
at least partial biodegradation of the at least one sensor and/or of the at least one emitter.

18. The method according to claim 17 comprising analyzing the data transmitted by the at least one emitter to determine at least a physical property and/or an image of a subsurface around the at least one probe.

19. The method according to claim 17 comprising generating a seismic stimulus in the ground, the measurement comprising collecting a seismic signal resulting from the seismic stimulus with the at least one sensor.

20. The ground probe according to claim 11, wherein the sensor is a geophone

21. The ground probe according to claim 11, wherein the sensor is a MEMS.
